(19) United States
(12) Patent Application Publication
(10) Pub. No.: US 2002/0037001 A1
(43) Pub. Date: Mar. 28, 2002

(54) VoIP phone line eliminator

(75) Inventor: Yucheng Jin, Chal font, PA (US)

Correspondence Address: Daniel H. Golub, Morgan, Lewis & Bockius LLP, 1701 Market Street, Philadelphia, PA, 19103-2921, US

(73) Assignee: General Instrument Corporation

(21) Appl. No.: 09/850,377

(22) Filed: May 7, 2001

Related U.S. Application Data
(60) Provisional application No. 60/236,234, filed on Sep. 28, 2000.

(51) Int. Cl. H04L 12/66

(52) U.S. Cl. 370/352; 370/356; 370/401

(57) ABSTRACT

An apparatus and associated method for simultaneously delivering multiple telephony services over a communications network. The apparatus having a single telephone cable and a plurality of sets of telephone/demultiplexer units connected to the single telephone cable. Each one of the telephone/demultiplexer units includes a demultiplexer and telephone device. Each one of the demultiplexers of the plurality of sets of telephone/demultiplexer units are connected to the single telephone cable. Each one of the telephone devices of the plurality of sets of telephone/demultiplexer units are connected to its respective demultiplexer. Each of the telephone/demultiplexer units are configured to generate a demultiplexed voice data stream in response to the multiplexed voice data stream.

### FIELD OF THE INVENTION

This invention relates to telephony systems, and more particularly to Internet based telephony systems.

### BACKGROUND OF THE INVENTION

As society has become more technologically oriented, the number of electronic communication devices within our homes and workplaces have proliferated. A matter of decades ago, the only communication device that used to be present in our home might be telephone. Now, it is not uncommon for our homes to have computers, either analog or digital telephones, and/or faxes in a single home. Often, these multiple electronic communication devices are provided with devoted cabling and lines. Additionally, much of the recent communication equipment requires much higher bandwidth to operate. For example, teleconferencing systems in which both video and digital signals are being transmitted often requires an extensive band width to operate properly, especially where full-duplex communication is provided between multiple parties. Electronic communication devices have become more sophisticated both within our offices and homes around the world. Additionally, it is often desired for a single dwelling to have multiple dedicated phone lines.

Providing such dedicated services to a single telephone (not a party line), typically requires dedicated cables and/or lines for each telephone. Therefore, if it is desired to put three dedicated telephone lines in the house, then typically three distinct sets of telephone cables and telephone lines must be run to each of the telephones. For individuals who are constructing new houses in which multiple dedicated telephone line service is anticipated, additional expenses associated with running the multiple telephone cables and lines can be considerable. As such, such individuals may elect not to run the number of dedicated telephone lines based upon cost considerations. In already-constructed houses, the cost of installing new dedicated lines is extremely expensive. Those lines have to be installed through dry wall, flooring, or whatever surface must be breached to install the lines. In rental property or offices, a tenant may be limited in the number of dedicated phone lines that they can run based on what is allowed to be installed through the rental premises, e.g., typically one plain old telephone system (POTS) line.

There are a wide variety of technologies that may be provided for telephone, fax, computer, and/or other communication equipment. Recently, there has been a drive to integrate many of these communication technologies. For example, Voice over Internet Protocol (VoIP) systems have been developed in which voice signals can be carried in a full-duplex manner over the network. The VoIP systems permit communication with the VoIP telephones with the existing traditional telephones, by using pathways between the Internet and the local exchange carrier (LEC) networks. Digital telephone networks have also been provided wherein the telephone signals can be transmitted in a digital fashion.

Communications gateways have been developed to provide cable television, traditional television, and recently computer and VoIP services to homes and/or offices. Communications gateways are typically sized to be installed within, on the side of, or proximate a dwelling or office. As per VoIP telephone service, it is typical for certain communications gateways (CG) to have only one telephone cable. Therefore, if it is desired to install another telephone, then the second CG may be necessary. One embodiment of a CG is shown in FIG. 5. CG 17 comprises a hybrid fiber coaxial media access control physical layer HFC (MAC/PHY) 26, and a controller 39 that includes a memory 28, a CPU 30 and a media terminal adapter (MTA) 27. The CG 17 further comprises, a DSP 32, a coder/decoder (CODEC) 38, a subscriber line interface circuit (SLIC) 40, a ringer 33, a protection device (PD) 42, and an associated telephone cable running out to a RJ11 or terminal Tip/Ring pair connector 20. A single devoted telephone will fit into the single RJ11 or terminal Tip/Ring pair connector 20. An ethernet media access control physical layer (MAC/PHY) 29 provides an interface between a PC or hub 31 and the memory 28. A RJ45 computer adapter 35 connects the PC or hub 31 to the MAC/PHY 29. A detailed description is provided in the detailed description for each of these elements that corresponds to a similarly-numbered element.

Therefore, it would be desired, to provide the device by which multiple devoted telephones can be connected to a single telephone line within a house or office. In another aspect, it will be desired to configure a communications gateway so that multiple devoted telephone lines can communicate with a single communications gateway, wherein the gateway is configured to handle only a single telephone cable.

### SUMMARY OF THE INVENTION

The present invention is directed to an apparatus and associated method for providing voice over Internet (VoIP) voice communications. The apparatus simultaneously delivers multiple telephony services over a communications network. The apparatus comprises a single telephone cable and a plurality of sets of telephone/demultiplexer units connected to the single telephone cable. Each one of the telephone/demultiplexer units includes a demultiplexer and telephone device. Each one of the demultiplexers of the plurality of sets of telephone/demultiplexer units are connected to the single telephone cable. Each one of the telephone devices of the plurality of sets of telephone/demultiplexer units are connected to its respective demultiplexer. Each of the telephone/demultiplexer units are configured to generate a demultiplexed voice data stream in response to the multiplexed voice data stream.

In another aspect, the invention is directed to a communications gateway that is configured for transmitting and receiving voice communication data to a plurality of telephone/demultiplexer units over a single external telephone cable. The communications gateway comprises, a computer memory, a central processing unit that is coupled to the computer memory, a digital signal processor that is coupled to the computer memory and the central processor unit. The communications gateway further comprises a multiplexer that is coupled to the digital signal processor and the single external telephone cable. The multiplexer is configured to transmit and receive the voice communication data.

In yet a further aspect, the invention is directed to a telephony adapter for adapting transmission of transmitted and received voice communication data to a telephone device over a single external telephone cable. The telephony adapter comprises a demultiplexer coupled to the single external telephone cable and a coder/decoder coupled to the demultiplexer. The telephony adapter also has a subscriber line interface connection that is coupled to the coder/decoder. The subscriber line interface connection is configured to adapt the transmission of the transmitted and received voice communication data.

### BRIEF DESCRIPTION OF THE DRAWINGS

The accompanying drawings, which are incorporated herein and constitute part of this specification, illustrate the presently preferred embodiment of the invention, and, together with the general description given above and the detailed description given below, serve to explain features of the invention. In the Figures:

FIG. 1 is a block diagram of one embodiment of a VoIP telephony system of the present invention;

FIG. 2 is a block diagram of one embodiment of the communications gateway of the VoIP system shown in FIG. 1;

FIG. 3 is a block diagram of one embodiment of the telephony adapter of the VoIP system shown in FIG. 1;

FIG. 4 is a timing diagram of one embodiment of the format for transmission of digital data between a time division multiplexer and a demultiplexer using the single cable as shown in FIGS. 1 to 3; and

FIG. 5 is a block diagram of one embodiment of prior-art communications gateway.

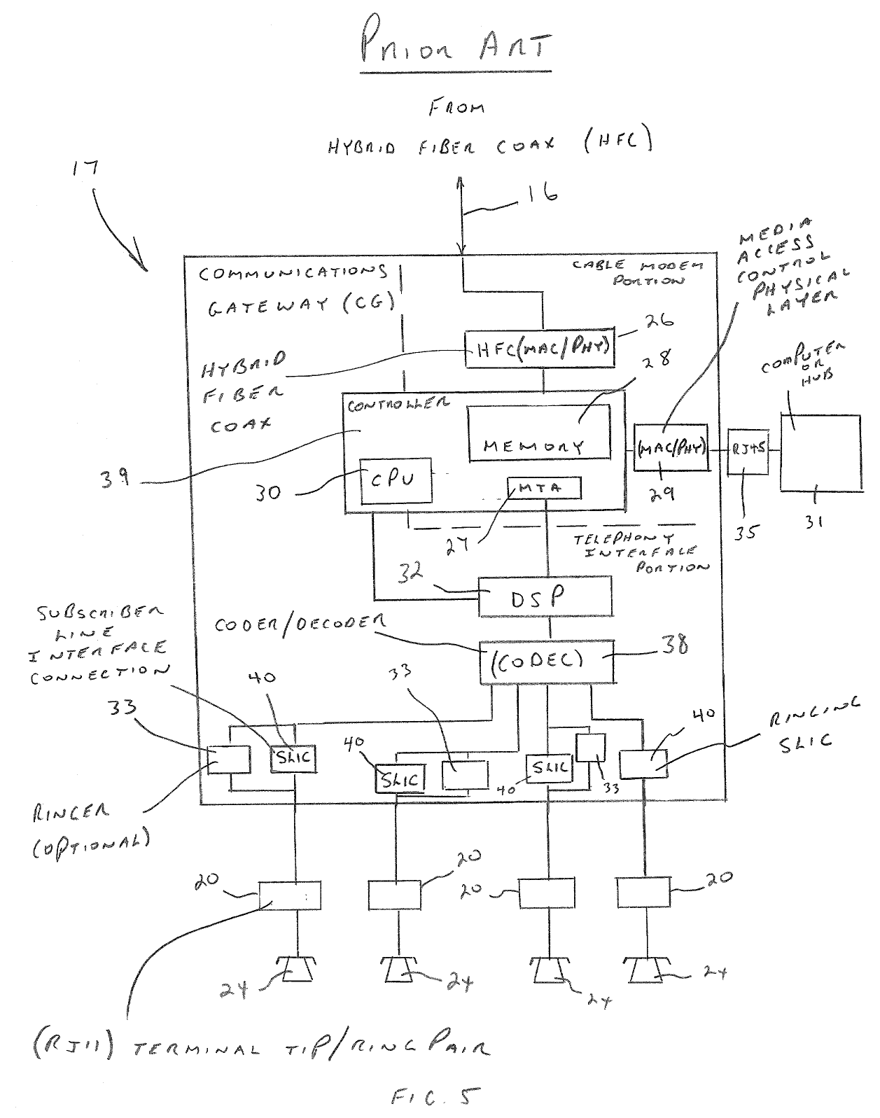

### DETAILED DESCRIPTION OF THE EMBODIMENT

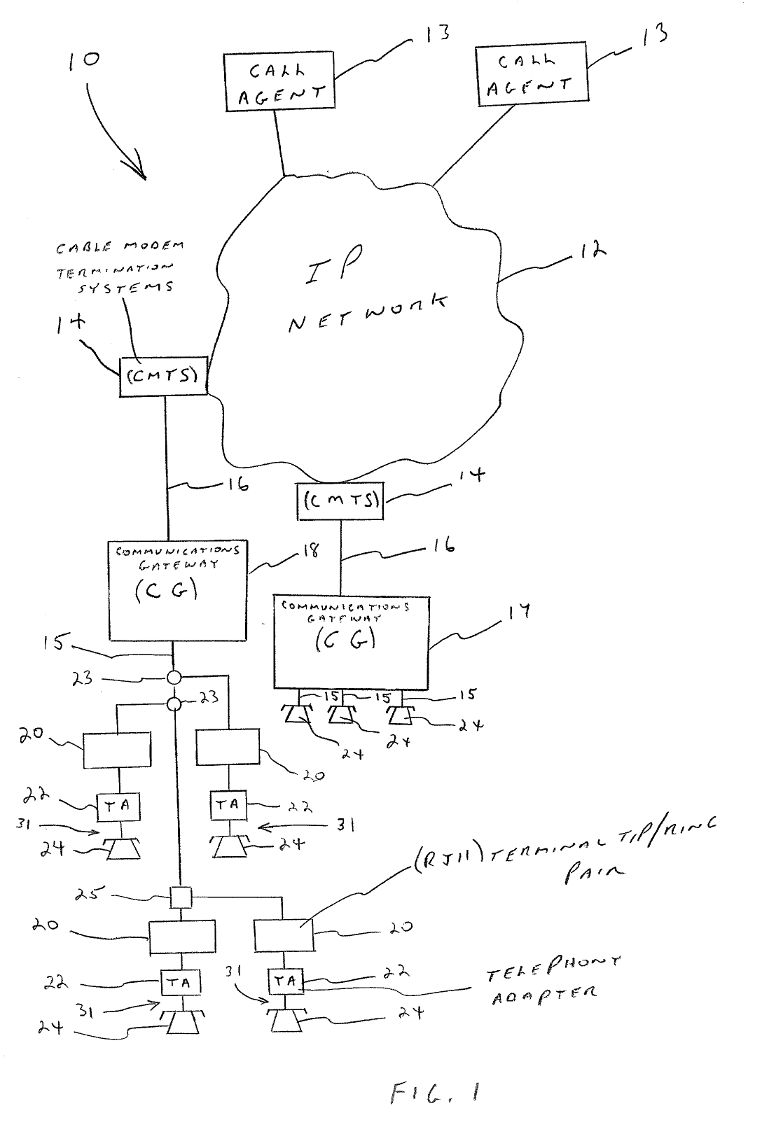

There is shown in FIG. 1, a diagram of a Voice over Internet (VoIP) system 10 that provides a unique means of distributing multiple telephony services from a communications gateway 18 over a single telephone cable 15 to a plurality of telephone devices 24. The general structure of the VoIP system 10 is described. A method for simultaneously delivering services to multiple telephones 24 over the VoIP system 10 over a single telephone cable is also described.

The VoIP system 10 comprises an Internet (IP) network 12 and a plurality of call agents 13 connected to the IP network 12 that initiate, maintain and terminate calls in the IP network 12. A different service provider may operate each call agent 13. Each call agent 13 may use a different control language, such as Network Control System (NCS), Simple Gateway Control Protocol (SGCP), Multimedia Gateway Control Protocol (MGCP), GR303, and others to initiate, maintain, and breakdown the phone calls. The call agent 13 acts as a master of set-up and tear down for VoIP voice communications. The call agent 13 physically includes a computer structure that includes the hardware to provide the necessary signals to initiate, monitor, regulate, and terminate VoIP communication. Each call agent 13 maintains a call state, performs phone number to IP address translations, and implements class features.

The VoIP system 10 further comprises a plurality of cable modem termination systems (CMTS) 14 that are coupled to the network 12. The plurality of the CMTS's 14 are connected to a plurality of hybrid fiber coax (HFC) 16 networks. A communications gateway (CG) 18 is coupled to one of the plurality of HFC's 16. HFC 16 allows CG 18 to communicate via the CMTS 14 over the IP network 12. The CMTS 14 can be configured to provide for data, cable TV, and/or telephone applications. CG 18 is configured to be mounted externally to a customers premise. Alternately, CG 18 may be mounted on the interior of a customer's premise as well if required.

CG 18 is coupled to multiple connectors 23 and a splitter 25 via the single telephone cable 15. The single telephone cable 15 generally includes a standard single pair of telephone wires. The connectors 23 and the splitter 25 are each coupled to a phone jack RJ11 or terminal Tip/Ring pair 20 although it is to be understood that the RJ11 or terminal Tip/Ring pair(s) 20 can be connected directly to the CG 17. The RJ11 or terminal Tip/Ring pair's 20 are generally mounted on the interior of the customers premise. A plurality of telephony adapters (TA) 22 are connected to each of the RJ11 or terminal Tip/Ring pair's 20. Each TA 22 is connected to a corresponding telephone device 24. The TA 22 can operate from a wall-mount AC adapter or (ideally) it can draw power from the telephone line directly. The TA 22 may be connected to different types of telephone devices 24. The different types of telephone devices 24 include, telephones, fax machines, or any other telephony service device. Splitter 25 is connected through multiple RJ11 or terminal Tip/Ring pair's 20 and multiple TA's 22 to multiple corresponding telephone devices 24. The CG 18 arrangement as shown in FIG. 1 significantly reduces the telephone line wiring effort.

Alternately, as shown in FIG. 1, CG 17 enables service to multiple telephony devices 24 in a premise. To distribute these services to their ultimate destination, multiple telephone cables 15 can be used, one for each telephone device 24. The customer is required to run multiple cables 15 between the CG 17 and the telephone devices 24. If a telephone device 24 is to be moved to a different location, the cabling 15 has to be adjusted accordingly.

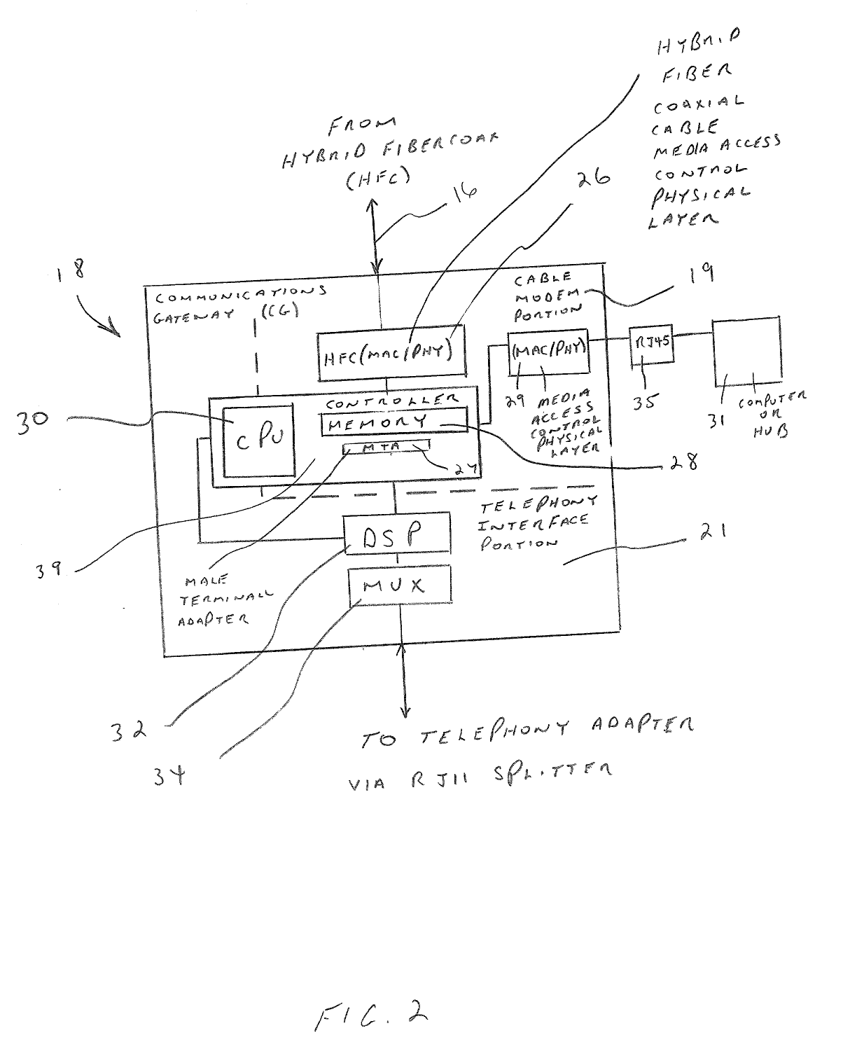

FIG. 2 illustrates the internal hardware components of the CG 18 of the present invention. A hybrid fiber coaxial cable ethernet media access control physical layer HFC (MAC/PHY) 26 is coupled to the hybrid fiber coaxial cable 16. The HFC MAC/PHY 26 is coupled to a controller 39. A CPU 30, a media terminal adapter (MTA) 27 and a memory 28 are integrated into the controller 39. The memory 28 may include read only memory (ROM) or random access memory (RAM) portions. The MTA 27 acts under the control of the call agent 13. An Ethernet media access control physical layer (MAC/PHY) 29 is coupled to and provides an interface between a PC or hub 31 and the controller 39. The MTA 27 is controlled by the respective call agent 13 to monitor events occurring at the telephone device 24, and report events (e.g., an off-hook condition) to the call agent. The MTA 13 sets up and tears down real time protocol (RTP) data streams as commanded by the call agent. Each call agent 13 operates independently, under the control of an associated provider, to command its respective MTA 27 to monitor VoIP events, establish signal tones, and set up or tear down RTP voice data streams.

The controller 39 is coupled to a digital signal processor (DSP) 32. The DSP 32 performs such voice processing protocol as compression, decompression, dial tone recognition, Dual Multi-Frequency (DTMF) tone detection, echo cancellation, etc. A digital telephone multiplexer (MUX) 34 is coupled to the DSP 32. The MUX 34 transmits and receives voice data from each one of the TA's 22. The MUX 34 provides full duplex communications characteristics with the multiple TA 22. A cable modem portion 19 of the CG 18 is comprised by the HFC MAC 26, the MAC/PHY 29 and the controller 39. The HFC MAC 26 provides an interface (e.g. OSI layer 2) between the HFC 16 and the controller 39. A telephony interface portion 21 of the CG 18 is comprised by the DSP 32, the MUX 34, and the controller 39. The telephony interface portion 21 is configured to provide IP network 12 voice communications to, e.g., one or more telephone devices 24. The CPU 30 controls and manages the processes occurring within the CG 18 by data transfer and data storage between the components of the CG 18. The PC or hub 31 is connected to the MAC/PHY 29 via an RJ45 computer adapter 35. The communication gateway therefore not only provides VoIP telephone service over the telephone devices 24, but also provide for computer networking (e.g. Internet) service. Different protocols, memory locations, and CPU allocations are utilized by the communications gateway in providing the telephone services and the computer networking services.

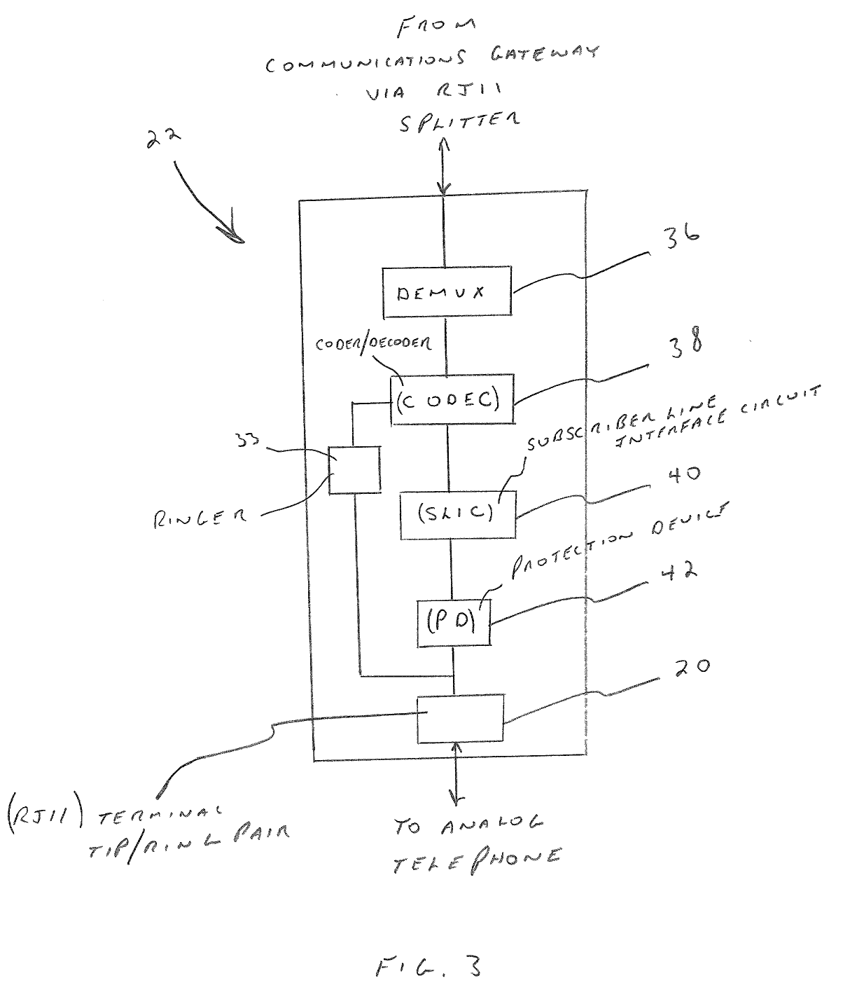

FIG. 3 illustrates the internal hardware components of one of the plurality of TA's 22 of the present invention. The TA 22 includes a digital telephone dumltiplexer (DEMUX) 36, a coder/decoder (CODEC) 38, a subscriber line interface channel (SLIC) 40, a ringer 33, a protection device (PD) 42, and a RJ11 or terminal Tip/Ring pair 20.

Referring to FIG. 2 and FIG. 3, the DEMUX 36 is configured to generate a demultiplexed voice data stream in response to the multiplexed voice data stream transmitted from the MUX 34. The DEMUX 36 provides full duplex communications characteristics. The DSP 32 generates pulse code modulation (PCM) signals that are sent to the coder/decoder (CODEC) 38. The DSP 32 processes received PCM signals originating from the telephone devices 24 via the CODEC 38, and transfers the processed signal to the cable modem portion 19 of the CG 18. The digital interface between the DSP 32 and the CODEC 38 uses pulse code modulation (PCM). The CODEC 38 receives digital information from the DSP 32 in the form of a bit-stream where, an amplitude of the incoming signal is related to a digital value (e.g., a digital 0 or 1) being sent. The CODEC 38 processes the PCM signals from the DSP 32, and generates an analog signal that is transmitted to the SLIC 40. In signals originating at the telephone device 24, the CODEC 38 samples the signal from the SLIC 40 and translates the discrete amplitude into a digital number that is sent to the DSP 32, thereby translating the voice signals received from the SLIC 40 into phase code modulated (PCM) signals that can be transferred to the DSP 32.

The SLIC 40 acts to connect the CG 18 with one telephone device 24. The SLIC 40 translates the analog signals received from the CODEC 38 into voice signals (voltage levels) that can be converted by the telephone device 24 into voices or audible noises. The SLIC 40 also transfers audio signals from a microphone of the telephone device 24 to analog signals that are received and processed by, the CODEC 38. The SLIC 40 provides an interface between the RJ11 or terminal Tip/Ring pair 20 and the CODEC 38. The ringer 33 produces a ring in a prescribed telephone device 24 when called from another telephone device 24. The function of the ringer 33 is often incorporated into the SLIC 40 to produce a so-called “ringing-SLIC 40.”

The protection device 42 is disposed between the SLIC 40 and the RJ11 or terminal Tip/Ring pair 20. The protection device 42 functions include operating as a surge protector or a current limitor. The SLIC 40 interfaces with the CPU 30 by sending an interrupt to the CPU 30, when necessary. The SLIC 40 uses an output signal to inform the CPU 30 of the occurrence of events at the telephone device 24. The SLIC 40 may also contain circuits for loop-back testing that is used to test the operation of the telephone device 24.

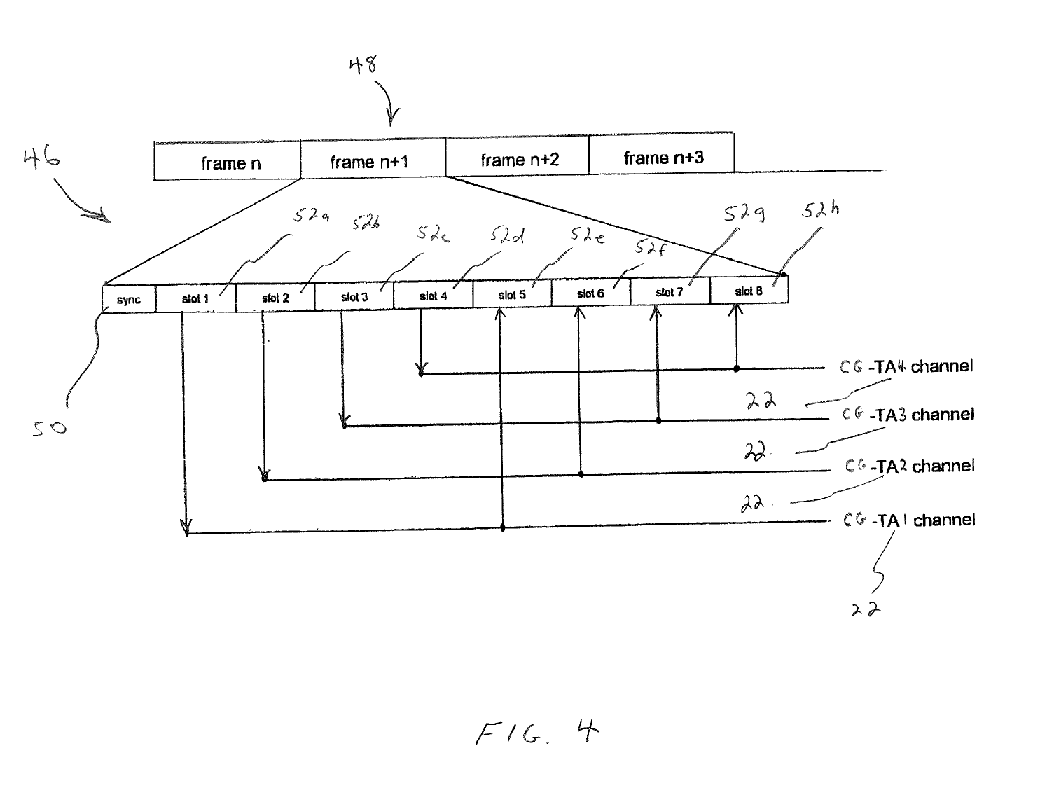

FIG. 4 is an illustration of the digital data 46 that is to be transmitted over the telephone cable 15. The data 46 is divided into frames 48. Each frame 48 has a synchronization (synch) symbol 50 plus eight sub-frames (slots) 52a, 52b, 52c, 52d, 52e, 52f, 52g, and 52h. The synch symbol determines the frames start position and the channel data that will be transmitted. Among the eight slots 52a-52h, four slots are dedicated for data 52a-52d that is transmitted from the CG 18 to the TA's 22. The other four slots 52e-52h are dedicated for transmission of data from the TA's 22 to the CG 18.

The MUX 34 controls transmission of data between the MUX 34 and each of the DEMUXs 36 in a full duplex manner. The MUX 34 starts a frame 48 by sending a sync symbol 50, that is received by each of the DEMUXs 36. Based on the sync symbol 50 the MUX 34 and all of the DEMUXs 36 understand that the slots 52a-52h are allotted for individual signal transmissions, in both directions, between the MUX 34 and the DEMUX 34. Each of the DEMUXs 36 are provided with appropriate timing, so they can transmit and/or receive on their allotted time slots 52a to 52h. For example, the MUX 34 allots slot 52e for signal transmission from the MUX 34 to the first telephone device 24 via the first TA 22 (including the first DEMUX 36). During time slot 52b, the MUX 34 allots to transmitting to the second telephone device 24. During time slot 52c, the MUX 34 allots to transmitting to the third telephone device 24 via the third TA (including the third DEMUX 36). During time slot 52d the MUX 34 allots to transmitting to the fourth telephone device 24 via the third TA (including the fourth DEMUX 36).

The time slots 52E-52H are allotted for communications from remote telephones to the MUX 34, which will be forwarded via the communications gateway over the hyper fiber coax network, and possibly the Internet, to another subscriber telephone similarly located in another VoIP system or another plain old telephony system. For example, in the time slot 52e, the MUX 34 allots time to receive a signal from the first telephone 24 that is transmitted over the first TA 22 using the first DEMUX 36. During time slot 52f, the second telephone 24, if it is on-line, will transmit via the second TA 22 including the second DEMUX 36 over a single telephone line 15 to be received by the MUX 34. During time slot 52g, the third telephone 24, if it is on-line, will transmit via the third TA 22 including the third DEMUX over a single telephone line 15 to be received by the MUX 34. During time slot 52h, the fourth telephone 24, if it is on-line, will transmit via the fourth TA 22 including the fourth DEMUX 36 over a single telephone line 15 to be received by the MUX 34. In this manner, the MUX 34, and each of its associated TAs or combined TAs, demultiplexer units allow for full duplex communications to be established between the communications gateway in each of the individual telephones 24.

While the principles of the invention have been described above in connection with the specific apparatus and associated method, it is to be clearly understood that this description is made only by way of example and not as a limitation on the scope of the invention.

What is claimed is:

1. An apparatus for simultaneously delivering mulitple telephony services over a communications network comprising:
a single telephone cable; and
a plurality of telephony devices connected to the single telephone cable.

2. The apparatus of claim 1, further comprising a digital telephone multiplexer connected to the single telephone cable.

3. The apparatus of claim 1, further comprising one digital telephone demultiplexer connected to each one said plurality of telephony devices.

4. The apparatus of claim 3, wherein the single telephone cable is connected to each one of the demultiplexers.

5. The apparatus of claim 2, wherein the digital telephone multiplexer is disposed in a communications gateway.

6. An apparatus for simultaneously delivering mulitple telephony services over a communications network comprising:
a single telephone cable;
a plurality of sets of telephone/demultiplexer units connected to said cable, each one of said telephone/demultiplexer units including a demultiplexer and telephone device, wherein each one of said demultiplexers of said plurality of sets of telephone/demultiplexer units are connected to said cable and each one of said telephone devices of said plurality of sets of telephone/demultiplexer units are connected to its respective demultiplexer; and
a multiplexer coupled to said cable, and generating voice data over said cable.

7. An apparatus for simultaneously delivering multiple telephony services over a VoIP voice communications network comprising:
a single telephone cable connected to the VoIP voice communications network;
a multiplexer generating a multiplexed voice data stream over and connected to said cable, wherein the digital telephone multiplexer is disposed in a communications gateway; and
a plurality of sets of telephone/demultiplexer units connected to said cable, each one of said telephone/demultiplexer units including a demultiplexer and telephone device, wherein each one of said demultiplexers of said plurality of sets of telephone/demultiplexer units are connected to said cable and each one of said telephone devices of said plurality of sets of telephone/demultiplexer units are connected to its respective demultiplexer, wherein each of said telephone/demultiplexer units are configured to generate a demultiplexed voice data stream in response to said multiplexed voice data stream.

8. A method for simultaneously delivering multiple telephony services over a communications network, the method comprising the steps of:
providing a single telephone cable; and
connecting a plurality of telephony devices to the single telephone cable.

9. The method of claim 8, further comprising providing a digital telephone multiplexer connected to the single telephone cable.

10. The method of claim 8, further comprising providing one digital telephone demultiplexer connected to each one said plurality of telephony devices.

11. A method for simultaneously delivering mulitple telephony services over a communications network, the method comprising the steps of:
providing a single telephone cable;
connecting a plurality of sets of telephone/demultiplexer units to said cable, each one of said telephone/demultiplexer units including a demultiplexer and telephone device, wherein each one of said demultiplexers of said plurality of sets of telephone/demultiplexer units are connected to said cable and each one of said telephone devices of said plurality of sets of telephone/demultiplexer units are connected to its respective demultiplexer; and
coupling a multiplexer to said cable, and generating multiplexed voice data over said cable.

12. A method for simultaneously delivering multiple telephony services over a communications network, the method comprising the steps of:
providing a single telephone cable;
connecting to said cable and generating a multiplexed voice data stream over said cable with a multiplexer, wherein the multiplexer is disposed in a communications gateway; and
connecting a plurality of sets of telephone/demultiplexer units to said cable, each one of said telephone/demultiplexer units including a demultiplexer and telephone device, wherein each one of said demultiplexers of said plurality of sets of telephone/demultiplexer units are connected to said cable and each one of said telephone devices of said plurality of sets of telephone/demultiplexer units are connected to its respective demultiplexer, wherein each of said telephone/demultiplexer units are configured to generate a demultiplexed voice data stream in response to said multiplexed voice data stream.

13. A communications gateway (CG) for transmitting and receiving voice communication data to a plurality of telephone/demultiplexer units over a single external telephone cable comprising:
a computer memory;
a central processing unit coupled to the computer memory;
a digital signal processor coupled to the computer memory and the central processor unit; and
a multiplexer coupled to the digital signal processor and the single external telephone cable being configured to transmit and receive said voice communication data.

14. The communications gateway of claim 13, wherein the hybrid fiber cable media access interface, the computer memory, and the shared central processor unit comprise a cable modem portion.

15. The communications gateway of claim 13, wherein the digital signal processor, the multiplexer, and the shared central processor comprise a telephony interface.

16. A telephony adapter for adapting transmission of transmitted and received voice communication data to a telephone device over a single external telephone cable comprising;
a demultiplexer coupled to the single external telephone cable;
a coder/decoder coupled to the demultiplexer; and
a subscriber line interface connection coupled to the coder/decoder, the subscriber line interface connection configured to adapt said transmission of the transmitted and received voice communication data.
